(19) United States
(12) Patent Application Publication
(10) Pub. No.: US 2004/0239502 A1
(43) Pub. Date: Dec. 2, 2004

(54) Storage battery loaded onto vehicle

(76) Inventors: Kenji Yamauchi, Takatsuki-shi (JP); Tomohiro Imamura, Takatsuki-shi Osaka (JP); Hiroyasu Kawada, Takatsuki-shi Osaka (JP); Hiroshi Tsunoda, Takatsuki-shi Osaka (JP); Kenzou Kawakita, Takatsuki-shi Osaka (JP); Masamichi Inakura, Takatsuki-shi Osaka (JP); Susumu Tanaka, Takatsuki-shi Osaka (JP)

Correspondence Address: LADAS & PARRY, 26 WEST 61ST STREET, NEW YORK, NY, 10023, US

(21) Appl. No.: 10/489,393

(22) PCT Filed: Oct. 28, 2002
(86) PCT No.: PCT/JP02/11157

(30) Foreign Application Priority Data
Oct. 29, 2001 (JP) 2001-331228
May 8, 2002 (JP) 2002-132226

(51) Int. Cl. G08B 13/14

(52) U.S. Cl. 340/568.1

(57) ABSTRACT

The present invention provides an electronic control unit, and particularly provides a storage battery that includes a burglary prevention device for storage battery loading equipment and for the storage battery loaded onto the storage battery loading equipment. The burglary prevention device includes a burglary sensor for detecting a burglar, and a burglary prevention signal output unit for outputting a signal that prevents the burglary when the burglary sensor detects the burglary.

### TECHNICAL FIELD

The present invention relates to a storage battery having an electrical control device. Specifically, the present invention relates to a storage battery that is loaded onto a vehicle and has a burglary prevention device for storage battery loading equipment and/or for the storage battery loaded onto the storage battery loading equipment.

### BACKGROUND ART

A burglary prevention technique for preventing a vehicle from being stolen is widely known. In this technique, a burglary prevention device is loaded onto the vehicle itself.

For example, Japanese Laid-Open Patent Publication No. 5-270359 discloses a burglary prevention device that is provided on a starting-up electrical power supply circuit for starting up a vehicle. This burglary prevention device includes a case holder having an electrical connection terminal which is inserted into the starting-up electrical power supply circuit and which is open all the time. This burglary prevention device further includes a license case having a case switch and having an outside connection terminal. When a driver's license is attached to the license case, a circuit of the case switch is closed, and an electrical current can flow through the case switch. The outside connection terminal is connected to the connection terminal of the case holder so as to electrically communicate with the starting-up electrical power supply circuit. In this burglary prevention device, when the license case to which a driver's license has been attached is loaded onto the case holder, the starting-up electrical power supply circuit is closed, and the engine is started up. In this manner, the theft of a vehicle is prevented.

According to the invention described in Japanese Laid-Open Patent Publication No. 5-270359, the burglary prevention device is provided at the starting-up electrical power supply circuit that is arranged outside a storage battery.

A technique in which the service life of a storage battery is displayed by the storage battery is known (for, example, Japanese Laid-Open Patent Publication No. 8-115751). However, a technique in which a storage battery and/or a vehicle having the loaded storage battery is prevented from being stolen by using the storage battery is not known.

As for the burglary prevention device for a vehicle, there is a problem. That is, in a case where a storage battery is removed from the vehicle, theft of the storage battery itself cannot be prevented.

Furthermore, according to the conventional burglary prevention device for preventing a vehicle from being stolen, the burglary prevention device needs to be separately installed, and there is another problem in that a compact size of the burglary prevention device cannot be realized.

### DISCLOSURE OF THE INVENTION

It is a general object of the present invention to provide an improved storage battery that solves the above-described conventional problems.

A more specific object of the present invention is to provide a storage battery loaded onto a vehicle. In other words, an electronic control device such as a burglary prevention device (or a theft prevention device) is installed to the storage battery in order to prevent the theft of a storage battery loaded onto storage battery loading equipment such as a vehicle, and prevent the theft of the storage battery. Thereby, it is possible to prevent the theft of the storage battery loading equipment or a burglary action of the storage battery loading equipment. The burglary prevention device is a device that has function of preventing a burglary, and/or has function of providing warning of a burglary.

In order to accomplish this object, according to the present invention, there is provided a storage battery loaded onto a vehicle in which the storage battery includes a burglary prevention device for storage battery loading equipment and/or for the storage battery loaded onto the storage battery loading equipment. The burglary prevention device includes a burglary sensor for detecting a burglary, and a burglary prevention signal output unit for outputting a signal that prevents a burglary when the burglary sensor detects the burglary.

Accordingly, the burglary prevention device can prevent the theft of the storage battery loading equipment, and/or the theft of the storage battery loaded onto the storage battery loading equipment by detecting the burglary and outputting the burglary prevention signal at the time of the burglary. In this specification, the vehicle to which the storage battery is loaded includes not only an automobile but also an airplane and a ship, which are transportation means.

Furthermore, in order to detect a burglary based on a voltage and/or a current of the storage battery, the burglary prevention device may include a storage battery voltage/current detection unit for detecting the voltage and/or the current of the storage battery. The burglary sensor may be configured so as to detect a burglary based on a change in the voltage and/or the current of the storage battery detected by the storage battery voltage/current detection unit.

With this configuration, the burglary sensor detects a burglary by detecting the change in the voltage or the current of an electrical system, or detecting the voltage and/or the current of the storage battery.

Further, in order to detect a burglary based on movement of the storage battery, the burglary sensor may include an acceleration detection unit for detecting acceleration of the storage battery. The burglary sensor may be configured so as to detect a burglary based on acceleration information of the storage battery detected by the acceleration detection unit.

With this configuration, the burglary sensor detects a burglary of the storage battery loading equipment and/or the theft of the storage battery loaded onto the storage battery loading equipment by detecting movement of the storage battery based on the acceleration information related to the movement of the storage battery.

In addition, in order to detect a burglary based on a position of the storage battery, the burglary sensor may include a position sensor for detecting the position of the storage battery. The burglary sensor may be configured so as to detect a burglary based on position information of the storage battery detected by the position detection unit.

With this configuration, the position detection unit detects the position of the storage battery, and the burglary sensor detects a burglary of the storage battery loading equipment and/or the theft of the storage battery loaded onto the storage battery loading equipment.

In a case where the storage battery loading equipment is a vehicle, in order to stop the engine of the vehicle at the time of a burglary, the burglary prevention signal generation unit may include an engine stop signal generation unit for generating an engine stop signal that causes the engine of the vehicle to be stopped. The burglary prevention signal generation unit may be configured so as to output the engine stop signal generated by the engine stop signal generation unit to an engine control unit of the vehicle.

With this configuration, by outputting the engine stop signal generated by the engine stop signal generation unit to the engine control unit of the vehicle at the time of a burglary, it is possible to stop the engine of the vehicle or perform control such that the engine does not operate. Thereby, it is possible to prevent the theft of the storage battery loading equipment and/or prevent the theft of the storage battery loaded onto the storage battery loading equipment.

Furthermore, in order to call a mobile communication terminal or a fixed communication terminal, the burglary prevention signal output unit may include a calling signal generation unit for generating a calling signal that calls the mobile communication terminal or the fixed communication terminal. The burglary prevention signal generation unit may be configured so as to output the calling signal generated by the calling signal generation unit to a burglary prevention signal output terminal to which a radio transmitter is connected.

With this configuration, by outputting the calling signal generated by the calling signal generation unit to the radio transmitter via the burglary prevention signal output terminal, it is possible to report a burglary of the vehicle at an earlier stage of the burglary, thereby preventing the burglary.

Further, in order to give an electrical shock to a burglar, the burglary prevention signal output unit may include an electrical shock signal generation unit for generating an electrical shock signal. The burglary prevention signal output unit may be configured so as to output the electrical shock signal generated by the electrical shock signal generation unit.

With this configuration, by outputting the electrical shock signal generated by the electrical shock signal generation unit of the burglary prevention device, it is possible to make it difficult for the thief to drive the vehicle, and to prevent a burglary of the storage battery loading equipment and/or the theft of the storage battery loaded onto the storage battery loading equipment.

In a case where the storage battery loading equipment is a vehicle, in order to lock the steering wheel of the vehicle at the time of a burglary, the burglary prevention signal output unit may include a steering wheel lock signal generation unit for generating a steering wheel lock signal. The burglary prevention signal output unit may be configured so as to output the steering wheel lock signal generated by the steering wheel lock signal generation unit.

With this configuration, by outputting the steering wheel lock signal generated by the steering wheel lock signal generation unit, it is possible to make it difficult for a thief to drive the vehicle, and prevent a burglary of the storage battery loading equipment and/or the theft of the storage battery loaded onto the storage battery loading equipment.

In a case where the storage battery loading equipment is a vehicle, in order to, when the vehicle is stolen, place the vehicle in a state which can be recognized as an extraordinary state (a state where the theft has been detected) from outside the vehicle, the burglary prevention signal output unit may include an extraordinary vehicle state signal generation unit for generating an extraordinary vehicle state signal that allows the vehicle state to be recognized as extraordinary from the outside. The burglary prevention signal output unit may be configured so as to output the extraordinary vehicle state signal generated by the extraordinary vehicle state signal generation unit.

With this configuration, by outputting the extraordinary vehicle state signal generated by the extraordinary vehicle state signal generation unit of the burglary prevention device, it is possible to make it difficult for a thief to continue to drive the vehicle, thereby preventing the theft.

The extraordinary vehicle state is a state that can be obviously recognized as extraordinary from outside the vehicle. For example, in the extraordinary vehicle state, the voice “This is a stolen car! This is a stolen car! . . . ” is repeatedly generated, a siren is turned on, a hazard warning light is turned on, or a horn is sounded. Accordingly, in the extraordinary vehicle state, it is not possible to smoothly drive the stolen vehicle.

In order to easily control operation start and operation stop of the burglary prevention device, the burglary prevention device may include a key group panel that can be operated from the outside of the burglary prevention device or the vehicle, and an operation start/stop control unit for controlling the operation start and the operation stop of the burglary prevention device. The burglary prevention device may be configured such that when a predetermined combination of numbers is input by using the key group panel, the operation start/stop control unit performs the operation start or the operation stop of the burglary prevention device.

With this configuration, the operation start or the operation stop of the burglary prevention device is performed by using the key group panel, and it is thereby possible to easily perform the operation start or the operation stop of the burglary prevention device.

Furthermore, by using a personal identification number, security can be improved.

Moreover, in order to easily perform operation start or operation stop of the burglary prevention device by radio, the burglary prevention device may include a control signal input terminal to which a control signal received by a radio receiver is provided, and an operation start/stop control unit for controlling the operation start or the operation stop of the burglary prevention device. The burglary prevention device may be configured such that the control signal provided via the control signal input terminal controls the operation start/stop control unit to perform the operation start or the operation stop of the burglary prevention device.

With this configuration, by performing the operation start or the operation stop of the burglary prevention device by radio, it is possible to easily perform the operation start or the operation stop of the burglary prevention device.

As for the manner in which the burglary prevention device is installed to the storage battery, the storage battery and/or the burglary prevention device may be configured such that the burglary prevention device can be attached to and detached from the storage battery.

With this configuration, after the service life of the storage battery expires, the burglary prevention device can be installed to another storage battery. In addition to that, when either the storage battery or the burglary prevention device breaks down, only the one of the storage battery and the burglary prevention device that was broken can be replaced with another one.

As for connection of the storage battery and the burglary prevention device, the storage battery and/or the burglary prevention device may be configured such that the power input terminal of the burglary prevention device is connected to a terminal of the storage battery in a state where the burglary prevention device is installed to the storage battery.

With this configuration, it is possible to connect the power input terminal of the burglary prevention device to the terminal of the storage battery by only installing the burglary prevention device to the storage battery.

According to the present invention, the storage battery may be a storage battery having an electronic control unit, elements of the electronic control unit may be united, and attachment and detachment of the electronic control unit can be easily carried out. The burglary prevention device can be incorporated in the electronic control unit. A storage battery service life predicting device or the like can be incorporated in the electronic control unit. The storage battery service life predicting device may have function of detecting the operation time of the storage battery, deterioration in electrical characteristics of the storage battery, the specific gravity (or density) of the electrolyte of the battery, and/or a change in the surface level of the electrolyte, and function of warning when the service life of the storage battery will expire soon. Elements of the burglary prevention device may be united in the electronic control unit, and thereby, the electronic control unit and the burglary prevention device can be easily attached to and detached from the storage battery.

Accordingly, after the service life of the storage battery expires, the electronic control unit can be installed to another storage battery, and can be continuously used. In addition to that, when either the storage battery or the electronic control unit breaks down, only the one of the storage battery and the electronic control unit that broke down can be replaced with another one.

Further, as for the connection of the storage battery and the electronic control unit, the storage battery and/or the electronic control unit may be configured such that a space for attaching the electronic control unit is provided on a surface of the storage battery, and an output terminal for connecting an input terminal of the electronic control unit is provided on an inner wall of this space.

With this configuration, it is possible to connect the power input terminal of the electronic control unit to the terminal of the storage battery by only attaching the electronic control unit to the storage battery.

As for a lock or a warning system of the electronic control unit, the electronic control unit may be configured so as to include the lock or the warning system for preventing the electronic control unit from being removed from the storage battery by a wrong hand.

With this configuration, it is possible to prevent the electronic control unit from being wrongly detached from the storage battery.

### BRIEF DESCRIPTION OF THE DRAWINGS

Other objects, features, and advantages of the present invention will become more apparent by reading the following description with reference to the accompanying drawings.

FIG. 1 shows an example of a first embodiment of the present invention.

FIG. 2 is a block diagram showing a configuration example of a burglary prevention device.

FIG. 3 is a block diagram showing a configuration example of a burglary sensor.

FIG. 4 is an illustration concerning burglary detection performed by a storage battery voltage detection unit.

FIG. 5 is a block diagram showing a configuration example of a burglary prevention signal generation/output unit.

FIG. 6 is a block diagram showing a configuration example of a control signal processing unit.

FIG. 7 is an illustration showing problems based on which a second embodiment of the present invention is provided.

FIG. 8 shows a first example of the second embodiment according to the present invention.

FIG. 9 shows a second example of the second embodiment according to the present invention.

FIG. 10 shows the burglary prevention device attached to a storage battery.

FIG. 11 is an illustration concerning the connection between power input terminals of the burglary prevention device and output terminals of the storage battery.

FIG. 12 shows a configuration of an electronic control unit that uses the storage battery as a power source.

### BEST MODE FOR CARRYING OUT THE INVENTION

Embodiments of the present invention will be described with reference to the drawings. The following description will be made on the assumption that storage battery loading equipment is a vehicle.

(First Embodiment)

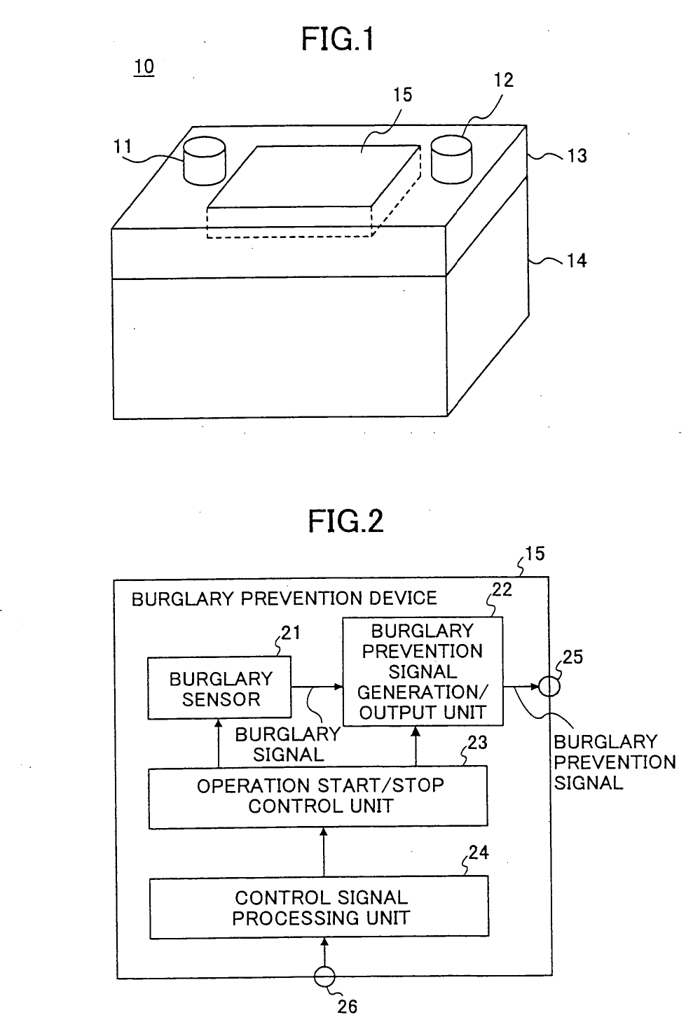

A first embodiment of the present invention is shown in FIG. 1. A storage battery 10 shown in FIG. 1 includes a plus terminal 11, a minus terminal 12, a cover 13 of the storage battery 10, a case 14 of the storage battery 10, and a burglary prevention device 15 (or a theft prevention device 15).

The case 14 of the storage battery 10 has a plurality of cells (not shown in the drawing). The cell is a container that accommodates electrolyte, and plates (positive plates and negative plates). For example, the case 14 is made of synthetic resins such as poly propylene, and chemical reaction occurs in the cell. A plurality of the cells are connected to each other in series. In this series connection, the positive plates located in the cell at one end of the battery are connected to the plus terminal 11, and the negative plates located in the cell at the other end of the battery are connected to the minus terminal 12.

The cover 13 of the storage battery is a cover for the case 14 of the storage battery. The plus terminal 11 and the minus terminal 12 are provided so as to penetrate the cover 13 of the storage battery.

The burglary prevention device 15 is disposed at a predetermined position inside the cover 13 of the storage battery. The burglary prevention device 15 includes a burglary sensor connected to the plus terminal 11 and the minus terminal 12 as described later, and includes a burglary prevention signal output unit. This burglary prevention device 15 has function of preventing a vehicle and/or the storage battery loaded onto this vehicle from being stolen.

A block diagram of the burglary prevention device 15 as one example is shown in FIG. 2. The burglary prevention device 15 shown in FIG. 2 includes a burglary sensor 21, a burglary prevention signal generation/output unit 22, an operation start/stop control unit 23, a control signal processing unit 24, a burglary prevention signal output terminal 25, and a control signal input terminal 26.

The burglary sensor 21 detects a voltage, acceleration, and/or a position of the storage battery in order to detect a burglary. The burglary prevention signal generation/output unit 22 receives a burglary signal from the burglary sensor 21, generates an engine stop signal, a calling signal, an electric shock signal, a steering wheel lock signal, and/or an extraordinary vehicle state signal, and outputs these signals from the burglary prevention signal output terminal 25 to an engine control unit, a radio transmitter, a steering wheel and/or a seat, a steering wheel lock unit, a hazard warning light control unit, and/or the like, respectively. The operation start/stop control unit 23 receives a signal from the control signal processing unit 24, and controls operation start or operation stop of the burglary prevention device 15. The control signal processing unit 24 receives a control signal that is provided by input at a key group panel and that is provided from outside the vehicle by radio, and controls the operation start/stop control unit 23. The control signal input terminal 26 is an input terminal for receiving the control signal provided from the outside by radio. As shown in FIG. 2, the operation start/stop control unit 23 may control operation of each of burglary sensor 21 and the burglary prevention signal generation/output unit 22. Alternatively, the operation start/stop control unit 23 may control a power supply that provides power to the burglary sensor 21 and burglary prevention signal generation/output unit 22, and in this manner, may control the burglary sensor 21 together with the burglary prevention signal generation/output control unit 23 so as to control the operation start or the operation stop of the burglary prevention device 15.

With this configuration, the burglary sensor 21 of the burglary prevention device 15 incorporated in the storage battery detects the burglary or the theft, and outputs a burglary signal to the burglary prevention signal generation/output unit 22. The burglary prevention signal generation/output unit 22 receives the burglary signal, and outputs a signal for preventing the burglary from the burglary prevention signal output terminal 25.

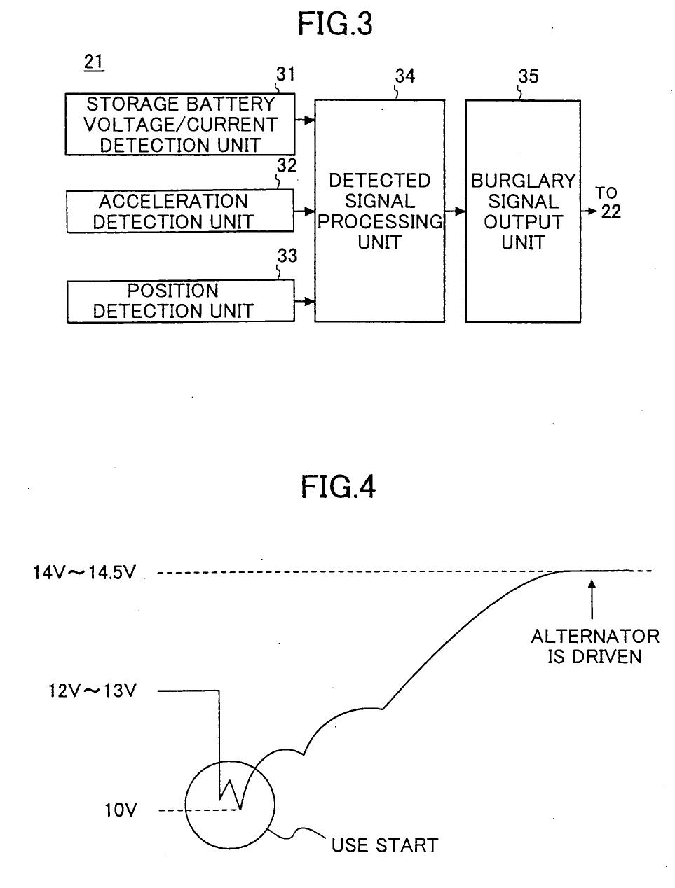

A block diagram of a configuration of the burglary sensor 21 as one example is shown in FIG. 3. The burglary sensor 21 shown in FIG. 3 includes a storage battery voltage/current detection unit 31 for detecting a current and/or a voltage of the storage battery, an acceleration detection unit 32 for detecting acceleration of the storage battery, a position detection unit 33 for detecting the position of the storage battery, a detected signal processing unit 34, and a burglary signal output unit 35.

The detected signal processing unit 34 receives detected signals from the storage battery voltage/current detection unit 31, the acceleration detection unit 32, and the position detection unit 33, and performs signal processing. As a result of this signal processing, when the burglary sensor 21 determines that a burglary has occurred, the burglary sensor 21 outputs the burglary signal from the burglary signal output unit 35 to the burglary prevention signal generation/output unit 22.

FIG. 4 illustrates burglary detection by the storage battery voltage/current detection unit 31. Generally, a storage battery provided in a vehicle maintains a voltage of 12 to 13 volts before the storage battery is used. However, when the storage battery is used, an electric current flows through a load, and the voltage of the storage battery temporarily drops (for example, drops to about 10 volts). After that, when the engine is started up, a dynamo (alternator) is started up, and the storage battery is charged. As a result, the voltage of the storage battery increases to about 14 to 14.5 volts. The voltage of the storage battery thus changes when the engine operates. Accordingly, although the vehicle does not move, when the engine is started up, it can be determined that the burglary is occurring.

The following is the detailed description of this burglary detection. The voltage of the storage battery has characteristics shown in FIG. 4. Accordingly, when the detected signal processing unit 34 of the burglary sensor 21 detects one of or both of a case \mathring{1} where the voltage of the storage battery drops to about 10 volts from 12 to 13 volts, and a case \mathring{2} where the voltage of the storage battery raises to a voltage equal to or higher than 14 volts, the burglary sensor determines that a burglary occurred, and outputs the burglary signal from the burglary signal output unit 35 to the burglary prevention signal generation/output unit 22.

In a case where when the burglary prevention device operates, the burglary sensor 21 detects a current, and it is determined that a room lamp or the like was turned on by a person. Accordingly, in the case where when the burglary prevention device operates, the burglary sensor detects a current, the storage battery voltage/current detection unit 31 and the detected signal processing unit 34 cause the burglary signal output unit 35 to output the burglary signal to the burglary prevention signal generation/output unit 22.

In another detecting manner, when the burglary sensor 21 detects acceleration of the storage battery, it is determined that a force is being applied to the vehicle and/or the storage battery loaded onto the vehicle because of a certain cause, and the storage battery is moving. In the case where when the burglary prevention device operates, the burglary sensor 21 detects the acceleration of the storage battery, the acceleration detection unit 32 and the detected signal processing unit 34 cause the burglary signal output unit 35 to output the burglary signal to the burglary prevention signal generation/output unit 22.

Furthermore, in a case where when the burglary prevention device operates, the burglary sensor 21 detects position movement of the storage battery by detecting the position of the storage battery by using the GPS (global positioning system) or the like, it is determined that the vehicle and/or the storage battery loaded onto the vehicle is moving because of a certain cause. Accordingly, in the case where when the burglary prevention device operates, the burglary sensor detects the acceleration of the storage battery, the position detection unit 33 and the detected signal processing unit 34 cause the burglary signal output unit 35 to output the burglary signal to the burglary prevention signal generation/output unit 22.

Moreover, it is possible to add position information to the calling signal at the calling signal generation unit 54, and to transmit the calling signal having the added position information. In this manner, an owner of the vehicle or a security company that has a contract with the owner of the vehicle can ascertain the position of the stolen vehicle.

In FIG. 3, the burglary sensor includes the storage battery voltage/current detection unit 31, the acceleration detection unit 32, and the position detection unit 33. However, the burglary sensor does not have to include all of the storage battery voltage/current detection unit 31, the acceleration detection unit 32, and the position detection unit 33. The burglary sensor may include at least one of the storage battery voltage/current detection unit 31, the acceleration detection unit 32, and the position detection unit 33.

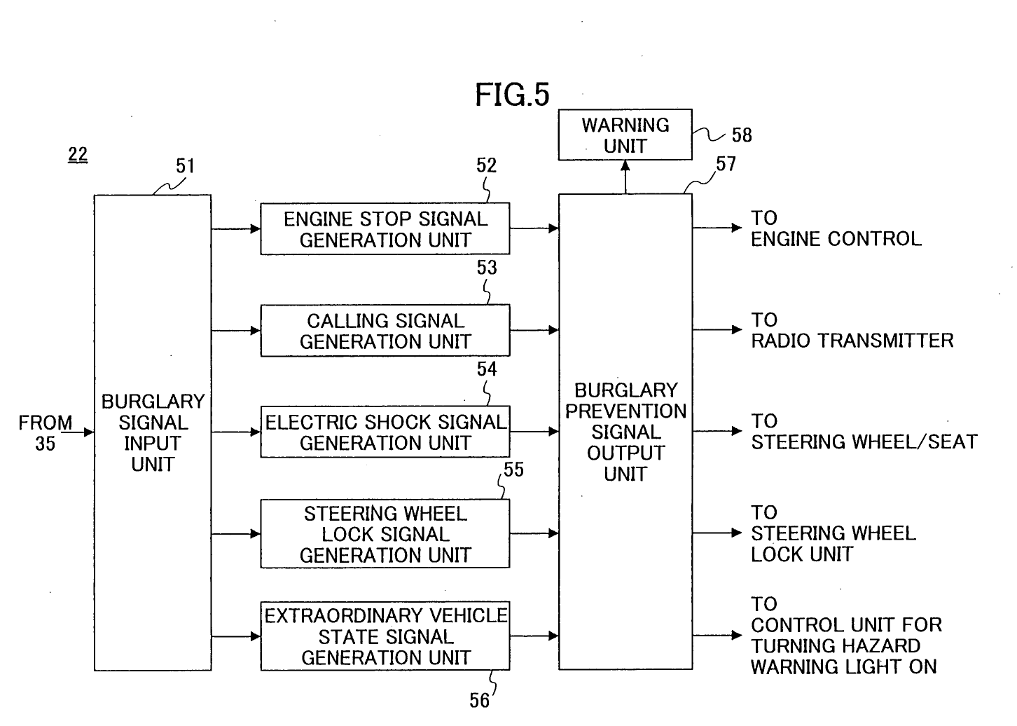

FIG. 5 shows one example of the burglary prevention signal generation/output unit 22. The burglary prevention signal generation/output unit 22 shown in FIG. 5 includes a burglary signal input unit 51, an engine stop signal generation unit 52, a calling signal generation unit 53, an electrical shock generation unit 54, a steering wheel lock signal generation unit 55, an extraordinary vehicle state signal generation unit 56, a burglary prevention signal output unit 57, and a warning unit 58.

The burglary signal input unit 51 receives the burglary signal from the burglary signal output unit 35, and outputs the burglary signal to the engine stop signal generation unit 52, the calling signal generation unit 53, the electrical shock generation unit 54, the steering wheel lock signal generation unit 55, and the extraordinary vehicle state signal generation unit 56. The engine stop signal generation unit 52 receives the burglary signal from the burglary signal input unit 51, and generates an engine stop signal. The warning unit 58 makes warning by sound or voice before the burglary prevention signal output unit 57 outputs the engine stop signal to the engine control unit. For example, the warning unit 58 generates warning “You seem to be stealing this car, so the engine will be forced to stop”. A similar warning may be displayed on entire glass, window, or the like facing the driver's seat at the same time of or instead of the voice warning. After the warning is generated, if the engine continues to operate, the burglary prevention signal output unit 57 provides the engine stop signal to the engine control unit (not shown), the engine gradually stops.

When the engine operates, the engine stop signal functions as a signal for stopping the engine. On the other hand, when the engine does not operate, the engine stop signal functions as a signal for preventing the engine from being started up. Alternatively, the burglary prevention device may be configured so as to monitor a state of the engine, and so as to generate the engine stop signal only when the engine operates.

The calling signal generation unit 53 receives the burglary signal from the burglary signal input unit 51, and generates the calling signal, and then, the burglary prevention signal output unit 57 provides the generated calling signal to a radio transmitter (not shown). The calling signal causes calling or sending of a telephone number for connecting a telephone machine of an owner of the vehicle or a security company that has a contract with the owner of the vehicle. Alternatively, by radio, the calling signal causes sending of the number for calling a device, which is called by radio, of the owner of the vehicle or the security company that has a contract with the owner of the vehicle. Either of a mobile terminal and a fixed terminal may be used as the telephone machine. In this case where the calling signal is used, it is preferable that the warning unit 58 does not generate a warning before the calling signal is used.

The electrical shock signal generation unit 54 receives the burglary signal from the burglary signal input unit 51, and generates the electrical shock signal for intermittently generating a high voltage. The warning unit 58 generates warning by voice or sound before the burglary prevention signal output unit 51 provides the electrical shock signal to a seat or a steering wheel of the vehicle. For example, the warning unit 58 generates the warning “You seem to be stealing this car, so you will receive a shock”. Alternatively, a similar warning may be displayed on entire glass, window glass, or the like facing the driver's seat at the same time of or instead of the voice or sound warning. In this case where the electrical shock is used, it is not necessary to generate the warning before the electrical shock is used. This is because if the burglary prevention signal output unit 57 provides the electrical shock signal to the steering wheel or the seat, and the electrical shock is given to the person trying to drive the vehicle, this person cannot continue to drive the vehicle.

The steering wheel lock signal generation unit 55 receives the burglary signal from the burglary signal input unit 51, and generates the steering wheel lock signal. The warning unit 58 generates warning by voice or sound before the burglary prevention signal generation unit 57 provides the steering wheel lock signal to a steering wheel lock mechanism. For example, the warning unit 58 generates the warning “You seem to be stealing this car, so the steering wheel will be locked”. After the generation of the warning, the burglary prevention signal output unit 57 provides the steering wheel lock signal to the steering wheel lock mechanism, and the steering wheel is locked.

The extraordinary vehicle state signal generation unit 56 receives the burglary signal from the burglary signal input unit 51, and generates the extraordinary vehicle state signal. The extraordinary vehicle state signal generation unit 56 provides the extraordinary vehicle state signal to a control unit for turning on a hazard warning light or the like (not shown) in order to turn the hazard warning light on.

Alternatively, the extraordinary vehicle state signal generation unit 56 receives the burglary signal from the burglary signal input unit 51, and generates a siren or horn control signal. A siren or horn control unit (not shown in the drawings) receives the siren or horn control signal from the burglary prevention signal output unit 57, and causes the siren or horn to sound.

In another example, the extraordinary vehicle state signal may cause the warning unit 58 to repeatedly generate the voice “This is a stolen vehicle! This is a stolen vehicle! . . . ”.

The burglary prevention signal generation/output unit shown in FIG. 5 includes the engine stop signal generation unit 52, the calling signal generation unit 53, the electrical shock signal generation unit 54, the steering wheel lock signal generation unit 55, the extraordinary vehicle state signal generation unit 56, and the burglary prevention signal output unit 57. However, the burglary prevention signal generation/output unit need not necessarily include all of the calling signal generation unit 53, the electrical shock signal generation unit 54, the steering wheel lock signal generation unit 55, the extraordinary vehicle state signal generation unit 56, and the burglary prevention signal generation/output unit 57. The burglary prevention signal generation/output unit may include at least one of these signal generation units shown in FIG. 5.

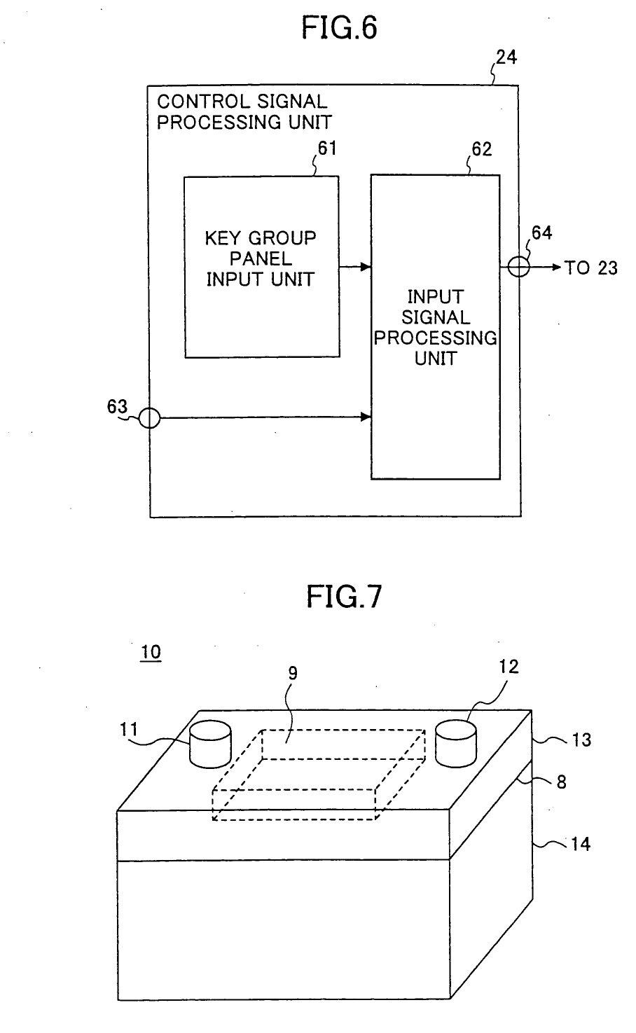

FIG. 6 is a block diagram illustrating an example of a control signal processing unit 24. The control signal processing unit 24 of FIG. 6 includes a key group panel input unit 61, an input signal processing unit 62, a control signal input terminal 63, and a control signal output unit 64.

In order to start operation of the burglary prevention device, the owner of the vehicle or the storage battery inputs a code that indicates operation start, and a personal identification number by using the key group panel input unit 61. The input signal processing unit 62 analyzes the code indicating the operation start, and the personal identification number. As a result of the analysis, when the personal identification number is correct, the input signal processing unit 62 outputs an operation start signal to the operation start/stop control unit 23 via the control signal output terminal 64. The operation start/stop control unit 23 receives the operation start signal from the control signal processing unit 24, and performs control so as to start operation of the burglary prevention device. Similarly to the operation start of the burglary prevention device, in order to stop operation of the burglary prevention device, the owner of the vehicle or the storage battery inputs a code indicating operation stop, and the personal identification number by using the key group panel input unit 61. The input signal processing unit 62 analyzes the code indicating the operation stop, and the personal identification number. Then, when the personal identification number is correct, the input signal processing unit 62 outputs an operation stop signal to the operation start/stop control unit 23 via the control signal output terminal 64. The operation start/stop control unit 23 receives the operation stop signal from the control signal processing unit 24, and performs control so as to stop operation of the burglary prevention device. The key group panel input unit 61 may include keys, buttons, or the like of characters or symbols other than number keys.

A radio receiver (not shown) is connected to the control signal input terminal 26. A control signal is input to the control signal input terminal 26 by using radio. The control signal is a signal based on the signal that is input by a key group panel input unit. A radio device for sending the control signal to be input to the control signal input terminal 26 may be a general portable terminal, or a radio control device particularly or exclusively used for the embodiments of the present invention.

The burglary prevention device may use the storage battery itself as a power supply, or a battery specially used for the burglary prevention device may be provided.

When the storage battery itself is used as the power supply, another power supply need not be used. When the battery specially used for the burglary prevention device is provided, even if the consuming amount of the power supply for the vehicle is large, and function of this power supply declines, the burglary prevention device can function because the consuming amount of the battery specially used for the burglary prevention device is small. In the first embodiment, the burglary prevention device is installed inside the cover of the storage battery. However, as long as the burglary prevention device and the storage battery are integrally configured such that appearance of the integrated configuration is recognized as a battery when viewed from the outside, the burglary prevention device does not have to be provided inside the cover of the storage battery.

The burglary sensor 21, the burglary prevention signal generation/output unit 22, the operation start/stop control unit 23, and the control signal processing unit 24 may include hardware of an integrated circuit or the like, or may include a microprocessor such that function of the control signal processing unit 24 is realized by software.

In the first embodiment, as one example, a lead-acid battery is used as the storage battery loaded onto the vehicle, but the present invention is not limited to the lead-acid battery. For example, an alkaline storage battery such as a nickel hydrogen battery, or a storage battery such as a lithium ion battery may be used as the storage battery in this embodiment. Furthermore, in this embodiment, the vehicle may include a hybrid type electric vehicle (HEV), an electric vehicle (EV), and a fuel-cell vehicle having a loaded storage battery.

(Second Embodiment)

In a second embodiment, the burglary prevention device of the first embodiment is attachably and detachably provided to a storage battery. In a configuration of the second embodiment, in a state in which the burglary prevention device is installed to the storage battery, power input terminals of the burglary prevention device are connected to terminals of the storage battery.

In FIG. 7, the storage battery of FIG. 1 includes the plus terminal 11, the minus terminal 12, the cover 13 of the storage battery, and the case 14 of the storage battery, and accommodates the burglary prevention device 15 at an inside space 9 of the cover 13.

The burglary prevention device 15 is strongly fixed so as to prevent the burglary prevention device 15 from being detached from the cover 13. In a case of the lead-acid storage battery, the case (container) 14 made of resin and the cover 13 of the storage battery are connected to each other at an interface 8.

For this reason, the burglary prevention device 15 which has been once installed at the inside space 9 of the cover 13 is not easily removed from the storage battery 10.

There is a case where the service life of the burglary prevention device 15 is much longer than that of the storage battery 10. However, as described above, the burglary prevention device 15 of FIG. 1 cannot be easily removed from the storage battery 10. There is a problem that when the service life of the storage battery lapses, the burglary prevention device 15 is disposed of at the same time the storage battery is replaced with new one.

Further, there is another problem that even if the storage battery functions normally, when the burglary prevention device 15 breaks down, the burglary prevention device 15 and the storage battery both need to be replaced with new ones.

According to the second embodiment of the present invention, in order to solve these problems, the burglary prevention device is attachably and detachably installed to the storage battery.

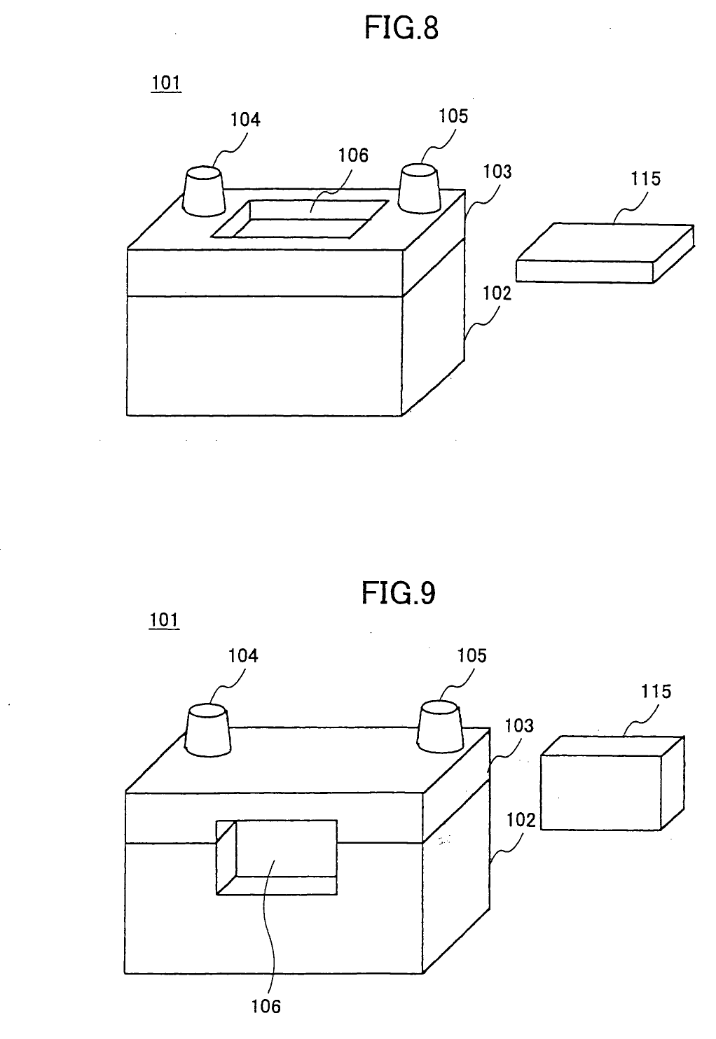

FIGS. 8 and 9 show a storage battery 101 loaded onto a vehicle, and a burglary prevention device 115 (or a theft prevention device 115). In FIGS. 8 and 9, the reference number 102 designates a resin-made container of the lead-acid storage battery, and the reference number 103 designates a resin-made cover which is placed on the container 102 and connected to the container 102 by melting or the like. The reference number 104 designates a lead-made or a lead-alloy-made positive terminal provided on an upper surface of the lead-acid storage battery, and the reference number 105 designates a negative terminal of the storage battery.

In FIGS. 8 and 9, the reference number 106 designates a space to which the burglary prevention device is attached. Appropriate shapes and sizes of the burglary prevention device 115 and the space 106 can be selected in accordance with necessity. In order to facilitate attachment and detachment of the burglary prevention device 115, the space 106 is provided at a surface portion of the storage battery 101 (the surface portion of the cover 103 and/or the container 102). The space 106 is formed by providing a recession on a wall of the cover 103 and/or the container 102. The space 106 is isolated from the inside space of the storage battery 101 by the existence of the wall of the cover 103 and/or the container 102.

A position where the space 106 is provided is not limited to a specific position on the surface of the storage battery. As shown in FIG. 8, the space 106 may be provided on the upper surface of the cover 103. As shown in FIG. 9, the space 106 may be provided on a side of the storage battery.

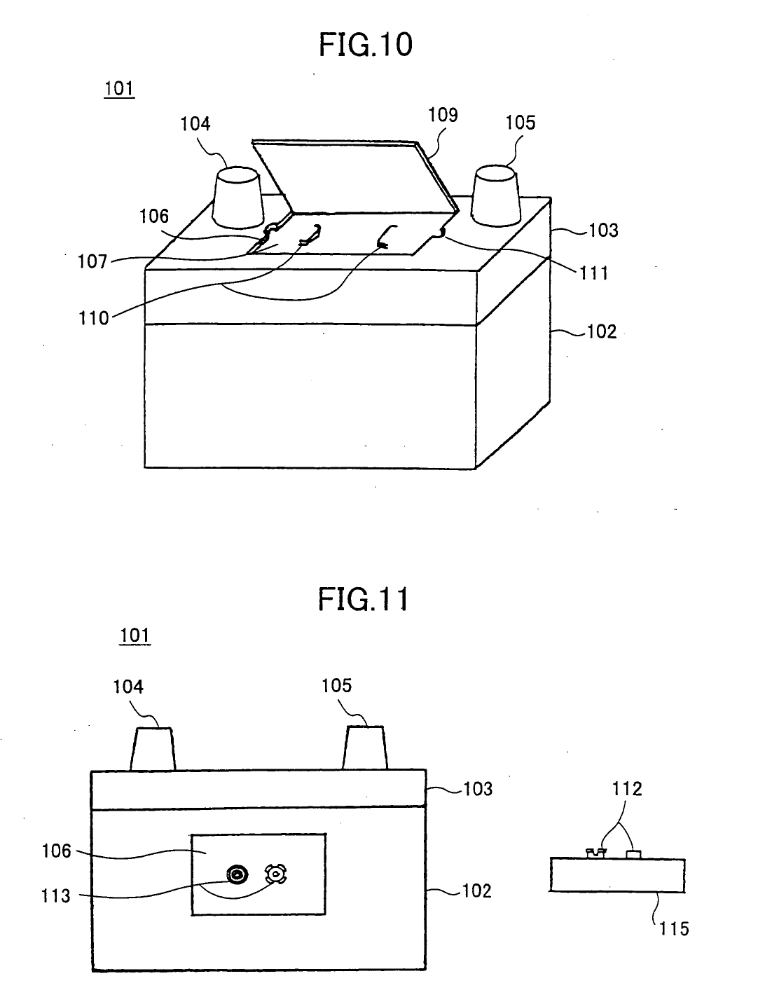

FIG. 10 shows the burglary prevention device 115 installed to the storage battery 101. In order to make the size of the inside space of the storage battery as large as possible, the size of the burglary prevention device is the same as the size of the space 106. Desirably, there is no gap between the burglary prevention device 115 and the space 106. For this reason, appropriate shapes and sizes of the burglary prevention device 115 and the space 106 can be selected in accordance with necessity. The shape and the size of the burglary prevention device 115 may be standardized, and the shape and the size of the space 106 may be set so as to correspond to the shape and the size of the burglary prevention device 115.

A method of fixing the burglary prevention device to the space 106 is not limited to a specific method. For example, as shown in FIG. 10, the burglary prevention device may be covered with a cover 109. In another method, adhesive tape may be provided on a wall of the burglary prevention device that faces the inside wall of the space 106, and the burglary prevention device is fixed to the space 106 by this adhesive tape.

In the state where the burglary prevention device 115 is installed to the space 106, the power input terminals of the burglary prevention device 115 are connected to the terminals of the storage battery 101.

In the second embodiment, output terminals for connecting to the power input terminals of the burglary prevention device 115 are preferably provided on the inside wall of the space 106 other than the positive terminal 104 and the negative terminal 105 provided on the upper surface of the storage battery 101. With this burglary prevention device 115, at the same time the burglary prevention device is installed to the space 106, the power input terminals of the burglary prevention device 115 are connected to the output terminals of the storage battery. Accordingly, a position of the power input terminals of the burglary prevention device 115 and a position of the output terminals of the storage battery 101 need to be standardized so as to be located at predetermined positions. The input terminals 112 of the burglary prevention device 115 and the output terminals 113 of the storage battery 101 may be configured to be jack terminals, snap terminals, plugs or connectors so as to connect the power input terminals of the burglary prevention device 115 to the output terminals of the storage battery 101. The output terminals 113 are connected to the terminals 104 and 105, respectively inside the cover of the storage battery 101.

In a case where the burglary prevention device 115 is attached to the space 106 without a gap between them, if a catching portion is not provided on the burglary prevention device 115, it is difficult to attach the burglary prevention device to the space 106 and detach the burglary prevention device from the space 106. In order to solve this difficulty, as shown in FIG. 10, depressions 110, a protruding catching portion, or a grip is provided on the surface of the burglary prevention device 115. Furthermore, as shown in FIG. 10, it is effective to provide a recession portion 111 at the inner walls of the space 106.

Moreover, in FIG. 10, the cover 109 may have a lock function. By the lock function, the burglary prevention device 115 cannot be detached by a wrong hand.

In a case where the storage battery has a built-in warning device which warns that the service life of the storage battery will lapse soon. However, the service life of the warning device can be much longer than that of the storage battery 101. Accordingly, it is effective to attachably and detachably provide the warning device to the storage battery as the burglary prevention device 115 can be attachably and detachably provided to the storage battery.

The burglary prevention device 115 of the second embodiment can be applied to the storage battery having the built-in warning device which warns that the service life of the storage battery will lapse soon.

Accordingly, it will be understood that the burglary prevention device 115 of the second embodiment can be widely applied to an electronic control unit that is incorporated in the storage battery and which uses the storage battery as a power source.

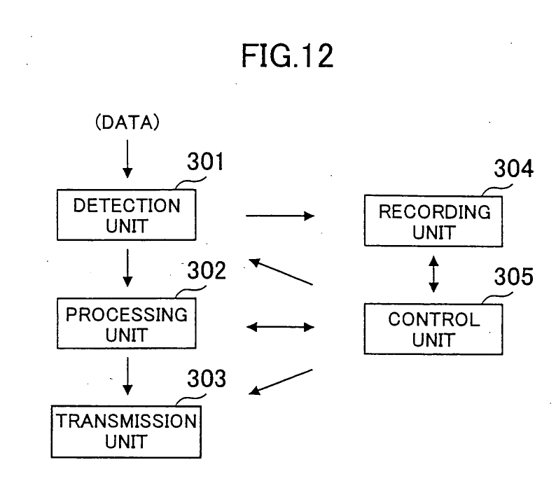

The electronic control unit that is incorporated in the storage battery and which uses the storage battery as a power source will be described with reference to FIG. 12.

The electronic control unit shown in FIG. 12 includes a detection unit 301, a recording unit 304 for recording data detected by the detection unit 301, a processing unit 302 for processing data detected by the detection unit 301, a transmission unit 303 for transmitting information based on data processed by the processing unit 302, and a control unit for controlling start and stop of a timer, the detection unit 301, the processing unit 302, the recording unit 304, and the transmission unit 303. Furthermore, the control unit 305 controls a process which is not performed by the detection unit 301, the processing unit 302, the recording unit 304, and the transmission unit 303. For example, when control of start and stop of the timer is not performed by the detection unit 301, the processing unit 302, the recording unit 304, and the transmission unit 303, or the control unit 305 controls the start and the stop of the timer.

In the present invention, the electronic control unit is not limited to the above-described electronic control unit, and any electronic control unit that is an electronic control device using a storage battery as a power source and whose elements are united may be applied to the present invention.

The detection unit detects a position, acceleration, vibration, inclination, a voltage, an electric current, a position of the surface of the electrolyte, and/or specific gravity (or density) of the electrolyte of the storage battery, for example. Necessary detection elements are incorporated in the electronic control unit. The recording unit and the processing unit typically may constitute a microcomputer. The recording unit may be used for recording a detection result detected by the detection unit. The processing unit may be used for performing an operation based on the detection result.

The following description is directed to a case where the electronic control unit is a warning device. The warning device which is the electronic control unit incorporated in the storage battery includes use start detection means for detecting start of use of the storage battery, time measurement means (timer) for starting time measurement at the time the detection means detects first start of the use of the storage battery, and warning means for generating warnings by using sound or visually at the time the time measurement means detects a predetermined time.

For example, the time measurement means (timer) measures a total operation time of the storage battery, and predicts the time that the service life of the storage battery will expire, based on the total operation time. Alternatively, the control unit may control the start and the stop of the timer, based on the detected voltage change of the storage battery and the detected current flowing in the storage battery. In another example, the detection unit detects a voltage and an internal impedance of the storage battery, the processing unit compares the detected value with a reference value to predict the time that the service life of the storage battery will expire, and the transmission unit performs transmission to communicate that the service life of the storage battery will expire soon. Furthermore, when the detected level of electrolyte in the storage battery becomes lower than a reference value, it is possible to send, to a user, information which urges the user to supply water.

The transmission unit typically sends an electrical signal, and in one example this electrical signal causes an engine stop system to be driven. In other examples, this electrical signal causes light (for example, light of a lamp), sound (for example, sound of an alarm or a buzzer), or a radio signal to be generated or sent. The light is generated from a lamp installed at an outside surface of the vehicle so as to be recognized from the outside. When loud sound is to be generated, it is possible to install a sound generator at the outside surface of the vehicle.

As described above, according to the second embodiment, by selecting functions to be incorporated in the electronic control unit, it is possible realize the electronic control unit possessing various functions. Furthermore, it is possible to select the electronic control unit to be incorporated in the storage battery, and to replace one electronic control unit with another electronic control unit in accordance with conditions or circumstances.

The present invention is not limited to the above-described embodiments. Various modifications or other specific forms can be embodied without departing from scope of claims of the present invention. For this reason, the above-described embodiments are shown as examples, and the present invention should not be interpreted as being limited to the above-described embodiments. The scope of the present invention is interpreted by claims of the present invention, and is not bound to the above description of this specification.

1. a storage battery for a vehicle, characterized in including an electronic control device that is incorporated in the storage battery, or is detachably provided to the storage battery.

2. The storage battery according to claim 1, characterized in that the storage battery functions as a power supply that supplies power to the electronic control device.

3. The storage battery according to claim 2, characterized in that the storage battery includes a space provided on a surface of the storage battery, the electronic control device is attached to the space, and an output terminal for connecting to an input terminal of the electronic control device is provided on an inner wall of the space.

4. The storage battery according to claim 2, characterized in that the storage battery includes a lock system or a warning system for preventing the electronic control device from being wrongly removed from the storage battery.

5. The storage battery according to claim 1, characterized in that the storage battery includes a burglary prevention device for storage battery loading equipment and/or for the storage battery loaded onto the storage battery loading equipment, and/or includes a storage battery service life warning device.

6. The storage battery according to claim 5, characterized in that the burglary prevention device includes a burglary sensor for detecting a burglary, and a burglary prevention signal output unit that outputs a signal for prevention of the burglary when the burglary sensor detects the burglary.

7. The storage battery according to claim 6, characterized in that the burglary sensor includes a storage battery voltage/current detection unit for detecting a voltage and/or a current of the storage battery, and the burglary sensor detects a burglary based on a change in the voltage and/or the current of the storage battery detected by the storage battery voltage/current detection unit.

8. The storage battery according to claim 6, characterized in that the burglary sensor includes an acceleration detection unit for detecting an acceleration of the storage battery, and detects a burglary based on information of the acceleration of the storage battery detected by the acceleration detection unit.

9. The storage battery according to claim 6, characterized in that the burglary sensor includes a position detection unit for detecting a position of the storage battery, and the burglary sensor detects a burglary based on information of the position of the storage battery detected by the position detection unit.

10. The storage battery loaded onto a vehicle according to claim 6, characterized in that when the storage battery loading equipment is a vehicle, the burglary prevention signal output unit includes an engine stop signal generation unit for generating an engine stop signal that causes an engine of the vehicle to be stopped,
and the burglary prevention signal output unit outputs the engine stop signal generated by the engine stop signal generation unit to an engine control unit of the engine.

11. The storage battery according to claim 6, characterized in that the burglary prevention signal output unit includes a calling signal generation unit for generating a calling signal that calls a mobile communication terminal or a fixed communication terminal,
and the burglary prevention signal output unit outputs the calling signal generated by the calling signal generation unit to a burglary prevention signal output terminal to which a radio transmitter is connected.

12. The storage battery according to claim 6, characterized in that the burglary prevention signal output unit includes an electric shock signal generation unit for generating an electric shock signal,
and the burglary prevention signal output unit outputs the electric shock signal generated by the electric shock signal generation unit.

13. The storage battery according to claim 6, characterized in that when the storage battery loading equipment is a vehicle, the burglary prevention signal output unit includes a steering wheel lock signal generation unit for generating a steering wheel lock signal that causes a steering wheel to be locked,
and the burglary prevention signal output unit outputs the steering wheel lock signal generated by the steering wheel lock signal generation unit.

14. The storage battery according to claim 6, characterized in that when the storage battery loading equipment is a vehicle, the burglary prevention signal output unit includes an extraordinary vehicle state signal generation unit for generating an extraordinary vehicle state signal so that a state of the vehicle can be recognized as extraordinary from outside the vehicle,
and the burglary prevention signal output unit outputs the extraordinary vehicle state signal generated by the extraordinary vehicle state signal generation unit.

15. The storage battery according to claim 6, characterized in that the burglary prevention device includes a key group panel that can be operated from the outside, and an operation start/stop control unit for controlling operation start or operation stop of the burglary prevention device,
and when a predetermined combination of numbers is input using the key group panel, the operation start/stop control unit performs the operation start or the operation stop of the burglary prevention device.

16. The storage battery according to claim 6, characterized in that the burglary prevention device includes a control signal input terminal to which a signal received by a radio receiver is provided, and an operation start/stop control unit for controlling operation start or operation stop of the burglary prevention device,
and the control signal provided via the control signal input terminal controls the operation start/stop control unit so as to control the operation start or the operation stop of the burglary prevention device.
